(19) United States
(12) Patent Application Publication
(10) Pub. No.: US 2024/0254638 A1
(43) Pub. Date: Aug. 1, 2024

(54) METHOD FOR PRODUCING COMPOSITE, METHOD FOR PRODUCING SLURRY CONTAINING COMPOSITE, METHOD FOR MANUFACTURING ELECTRODE, ELECTRODE, ION EXCHANGE MEMBRANE-ELECTRODE ASSEMBLY, AND CO2 ELECTROLYSIS DEVICE

(71) Applicant: IDEMITSU KOSAN CO.,LTD., Tokyo (JP)

(72) Inventors: Hiroyuki KANEKO, Tokyo (JP); Yuji OKAMOTO, Tokyo (JP)

(73) Assignee: IDEMITSU KOSAN CO.,LTD., Tokyo (JP)

(21) Appl. No.: 18/560,814

(22) PCT Filed: May 20, 2022
(86) PCT No.: PCT/JP2022/020924

§ 371 Date: Nov. 14, 2023

(30) Foreign Application Priority Data
May 21, 2021 (JP) 2021-086344

(51) Int. Cl. C25B 11/054; C25B 9/23; C25B 11/052; C25B 11/065; C25B 11/081

(52) U.S. Cl. CPC C25B 11/054; C25B 9/23; C25B 11/052; C25B 11/065; C25B 11/081

(57) ABSTRACT

A method for manufacturing a composite in which at least one of an elemental metal or a metal compound is carried on a carrier. The method includes exposing a dispersion liquid containing a solvent and the carrier to a reduced-pressure environment of less than 80 kPa (absolute pressure) at normal temperature, preparing a raw material mixture liquid by mixing a metal-ion supplying agent which is a metal ion source of the elemental metal or the metal compound with the dispersion liquid, and mixing a reducing agent with the raw material mixture liquid and causing the elemental metal or the metal compound to be carried on a surface of the carrier.

### TECHNICAL FIELD

The present disclosure relates to a method for manufacturing a composite, a method for manufacturing a slurry containing the composite, a method for manufacturing an electrode using the composite and the slurry, an electrode, an ion-exchange membrane-electrode assembly, and a CO₂ electrolytic apparatus.

### BACKGROUND ART

Fossil fuels (oil, coal, and natural gas) support a modern energy consuming society. The extraction of energy from the fossil fuels involves the emission of CO₂ (carbon dioxide). An increase in carbon dioxide concentration in the atmosphere is reported to be one of causes of global warming, and a decrease in the concentration is required. Since CO₂ is an extremely stable substance, it is difficult to reuse CO₂ through decomposition or the like, and there is a demand for new technologies for converting CO₂ into another substance and recycling CO₂ again.

As one of the technologies, research on the reduction of CO₂ using electric energy has been widely conducted all over the world. A CO₂ reductor having a polyelectrolyte-type electrolysis cell has been found to be superior to other devices in that movement resistance of ions can be sufficiently lowered by using a thin-film polyelectrolyte (Patent Literature 1). In general, a cathode for CO₂ reduction used in a polyelectrolyte-type electrolysis cell contains fine catalyst particles and a conductive carrier.

In the CO₂ reduction, the number of active sites on a surface of an electrocatalyst and a crystal plane significantly contribute to a reaction rate, and therefore it is desirable that electrocatalyst particles have a small particle size and be carried with high dispersion. As a method of dispersing and carrying metal particles of an electrocatalyst on a carrier, for example, there is a method of directly carrying metal particles of an electrocatalyst on a carrier by agitating the carrier, metal ions, and a reducing agent in an organic solvent for a long time (Non Patent Literature 1).

In addition, in the CO₂ reduction, the amount of CO₂ adsorption in the vicinity of a CO₂ reduction catalyst strongly contributes to the production efficiency of reduction products such as CO (carbon monoxide), and development of an electrocatalyst capable of adsorbing a large amount of CO₂ is also desired. For example, a method has been proposed in which an ion-exchange resin having a property of interacting with CO₂, such as adsorption, and a catalyst are caused to be co-carried on an electrode by a high-temperature and high-pressure treatment to increase an adsorption amount of weakly acidic CO₂ and improve the production efficiency (Patent Literature 3).

### CITATION LIST

### Patent Literature

Patent Literature 1: JP 2019-515142 A
Patent Literature 2: WO 2020/130078 A1
Patent Literature 3: JP 2012-43612 A

### NON PATENT LITERATURE

Non Patent Literature 1: K. Iizuka, T. Wato, Y. Miseki, K. Saito, A. Kudo, J. Am. Chem. Soc., 2011, 133, 20863.

### SUMMARY OF INVENTION

### Technical Problem

In general, a carbon carrier or a ceramic carrier is used as an electrocatalyst. Since the carbon carrier and the ceramic carrier are fine particles having hydrophobicity, air bubbles are likely to adhere thereto in a solution. In this manner, in a case where a catalyst such as metal particles is carried on a carrier, the metal particles are likely to be enlarged, and there is a possibility that a small particle size and high dispersion are likely to be insufficient. In addition, in co-carrying with the ion-exchange resin as described above, the catalyst and the resin may be altered through the high-temperature and high-pressure treatment, and costs of a process may be increased.

In this respect, an object of the present disclosure is to provide a technology relating to a composite in which at least one of an elemental metal or a metal compound having a small particle size and high dispersibility is caused to be carried on a carrier, and a slurry using the composite.

According to one aspect of the present disclosure, there can be provided a technology relating to a method for manufacturing a composite in which at least one of an elemental metal or a metal compound is caused to be carried on a carrier, the method including: a pressure reducing step (S1-1) of exposing a dispersion liquid containing a solvent and the carrier to a reduced-pressure environment of less than 80 kPa (absolute pressure) at normal temperature: a raw material mixture liquid preparing step (S1-2) of preparing a raw material mixture liquid by mixing a metal-ion supplying agent which is a metal ion source of the elemental metal or the metal compound with the dispersion liquid; and a carrying step (S1-3) of mixing a reducing agent with the raw material mixture liquid and causing the elemental metal or the metal compound to be carried on a surface of the carrier.

In addition, according to another aspect of the present disclosure, there can be provided a technology relating to a method for manufacturing a slurry containing a polymer material and a composite in which at least one of an elemental metal or a metal compound is caused to be carried on a carrier, the method including: a pressure reducing step (S2-1) of exposing a first dispersion liquid containing a solvent (A) and the composite to a reduced-pressure environment of less than 80 kPa (absolute pressure) at normal temperature; and a slurry preparing step (S2-2) of preparing a slurry by mixing the polymer material with the first dispersion liquid.

### Advantageous Effects of Invention

According to the present disclosure, there can be provided a technology relating to a composite in which at least one of an elemental metal or a metal compound having a small particle size and high dispersibility is caused to be carried on a carrier, and a slurry using the composite.

### BRIEF DESCRIPTION OF DRAWINGS

FIG. 1A is a flowchart illustrating a manufacturing method for preparing a composite used in the present embodiment. FIG. 1B is a flowchart illustrating a method for manufacturing a slurry composite used in the present embodiment.

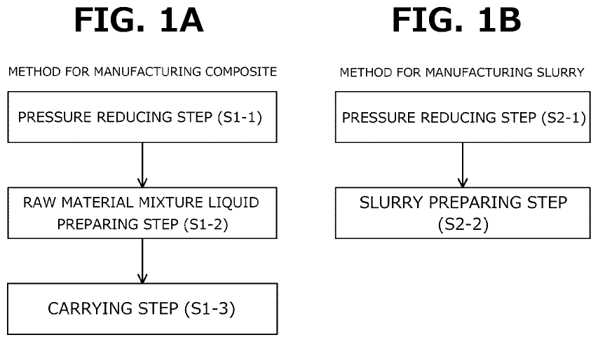

FIG. 2 is a schematic diagram illustrating a polymer coated composite in the present disclosure.

FIG. 3 is an example of a schematic view for illustrating an ion-exchange membrane-electrode assembly suitably used in the present disclosure.

FIG. 4 is an example of a schematic diagram illustrating an example of a CO₂ electrolytic apparatus suitably used in the present disclosure.

### DESCRIPTION OF EMBODIMENTS

Hereinafter, a method for manufacturing a composite and a method for manufacturing a slurry in the present disclosure will be specifically described. The inventions according to the present disclosure are not limited to embodiments to be described below.

In the present specification, “normal temperature” and “normal pressure” are to be construed in accordance with the description of JIS Z 8703-1983 “Standard Atmospheric Conditions for Testing”.

The present inventors have found that air bubbles are attached when a carrier is dispersed in a solvent in a process of carrying metal particles or the like on a carrier. The air bubbles not only interfere with carrying of the metal particles or the like on the carrier but also predominantly generate crystal nuclei due to a local concentration gradient in the vicinity of an unstable gas-liquid interface to result in an uneven distribution of precipitation sites of the metal particles or the like. In this respect, the present inventors have found that air bubbles can be discharged to the outside of the system by exposing the solvent to a reduced-pressure (for example, absolute pressure of 80 kPa or lower) environment for a predetermined time when a carrier is dispersed in a solvent, which results in suppressing partial generation of crystal nuclei, and the problem is solved, thereby completing the technologies disclosed herein.

### 1. Composite

The composite according to the present disclosure is, for example, a composite in which at least one of an elemental metal or a metal compound as a catalyst is caused to be carried on a carrier.

A metal content of a metal component of the elemental metal or the metal compound in the composite is not particularly limited as long as effects of the technologies disclosed herein are not impaired. For example, when a carrier content is 100 parts by mass, the metal content is 1 part by mass or more, preferably 10 parts by mass or more, and more preferably 20 parts by mass or more. The upper limit value of the metal content in the composite can be, for example, 100 parts by mass.

The metal content of the metal component of the elemental metal or the metal compound in the composite is measured by the following method. The metal content of the composite is measured using an X-ray fluorescence analyzer. Specifically, a calibration curve of a metal content and a detection peak of a predetermined metal is created in advance using an X-ray fluorescence analyzer for a powder having a carrier and a metal content of a predetermined metal which are already known, a detection peak of the predetermined metal of an actually prepared composite is measured using the X-ray fluorescence analyzer, and the metal content is obtained from the calibration curve.

An average particle size of the composite is not particularly limited as long as the effects of the technologies disclosed herein are not impaired, but the average particle size can be, for example, 200 nm or less, and is preferably 100 nm or less. The lower limit value can be 1 nm or more. The average particle size of the composite can be measured by calculating a number average value of particle sizes measured using a scanning electron microscope for 100 randomly selected particles. In the measurement, a length in the longest direction of an appearing composite particle is measured as a long diameter, and the long diameter is measured as the particle size.

The carrier is not particularly limited as long as the effects of the technologies disclosed herein are not impaired, and the carrier may be a solid substance capable of carrying and fixing an elemental metal or a metal compound. Examples of materials of the carrier include a carbon carrier, a metal carrier, a metal nitride carrier, a metal carbide carrier, and a metal oxide carrier. In addition, the carrier may have a particulate form, a fibrous form, or a sheet form.

When the composite is used as an electrode material containing a catalyst, the carrier is a conductive carrier. The conductive carrier preferably includes a carbon material, titanium, tantalum, gold, silver, or copper. The substances can be used alone or in combination of two or more. The substances can be selected in consideration of corrosion resistance. The conductive carrier is preferably made of a material different from that of the catalyst to be used.

Here, the carbon material is not particularly limited as long as the carbon material has conductivity and does not impair the effects of the technologies disclosed herein. As the carbon material, those known to be used for an electrode material can be used. For example, graphite carbon, glassy carbon, carbon black, graphene, carbon nanotubes, or the like can be used.

The carrier/conductive carrier has preferably a particulate form or short fibrous form. In addition, the carrier/conductive carrier may be an aggregate in which particles (primary particles) or short fibers are aggregated. Here, the term “particulate form or short fibrous form” indicates a shape that is determined to be a particulate form or a short fibrous form based on the general technical knowledge. In addition, in the present disclosure, an aggregate formed by aggregation of short fibers are also included in secondary particles.

An average particle size of the primary particles or an average fiber length of the short fibers of the carrier is not particularly limited as long as the effects of the technologies disclosed herein are not impaired, and the average particle size or the average fiber length may be, for example, 10 to 100 nm and is preferably 20 to 50 nm. The average particle size and the average fiber length of the conductive carrier can be freely selected in consideration of a surface area and the porosity of the conductive carrier. Here, the average particle size is an average particle size including primary particles or short fibers and secondary particles. Here, when the conductive carrier has a short fibrous form, the average particle size is a value obtained by averaging a particle size obtained by considering a fiber length of the short fiber as the primary particle size and a particle size of the secondary particles of the short fiber. The average particle size can be measured by measuring carrier particles for 100 randomly selected particles using a scanning electron microscope, measuring, as long diameters, lengths in the longest direction of the appearing particles, and calculating an average value of the obtained long diameters. Observation means can be selected depending on the average particle size. In addition, preferably, an average primary particle size of the carrier/conductive carrier is twice or more an average primary particle size of the catalyst.

A specific surface area of the carrier is not particularly limited as long as the effects of the technologies disclosed herein are not impaired, and the specific surface area can be, for example, 100 to 3,000 m²/g and is preferably 200 to 1,800 m²/g. When the specific surface area of the carrier is within such a range described above, a carrying amount of the elemental metal or the metal compound becomes sufficient, and the diffusibleness of CO₂ on a surface of a CO₂ reduction catalyst for CO₂ is good when a polymer coated composite to be obtained or the composite to be described below itself is used as the CO₂ reduction catalyst.

The hydrophobicity of the carrier is not particularly limited as long as the effects of the technologies disclosed herein are not impaired: however, when ion-exchange water is added dropwise to the carrier (obtained by molding a powder of the carrier into a thin film shape) in an environment of 25° C., for example, a contact angle between a tangent of a droplet and a surface of the carrier is preferably 80° to 140°. In a case where the contact angle is within such a range described above, a balance between hydrophilicity and hydrophobicity is good.

That is, when the hydrophobicity is too low (the hydrophilicity is too high), the catalyst activity decreases in a case of using, as a CO₂ reduction catalyst, a polymer coated composite obtained by spraying a slurry to be described below on a base material by a spray or the like, then removing a solvent (A) to be described below through drying or the like, and forming (co-carrying with the elemental metal or the metal compound) a coating layer in which a part or the whole of the composite surface is more uniformly coated with a polymer, or a composite manufactured by a method for manufacturing a suitable composite to be described below:

In addition, when the hydrophobicity is too high (the hydrophilicity is too low), the dispersibility of the carrier deteriorates, and thus the particle size of the composite increases.

The elemental metal and the metal compound as the catalyst according to the present disclosure are not particularly limited as long as the effects of the technologies disclosed herein are not impaired. In a case where the composite is used as the electrode material containing the catalyst, the elemental metal and the metal compound preferably contain any one of Au, Ag, Cu, Pt, Ir, Pd, Ru, Ni, Co, Mn, Bi, Sn, Zn, and Al. Here, the metal compound includes an alloy. In addition, the metal compound is preferably an oxide or a metal complex such as Ag, Cu, Ir, Pd, Ru, Ni, Co, Mn, Bi, Sn, Zn, or Al.

Examples of the metal oxide include a ruthenium oxide (RuO₂ or RuOₓ), a rhenium oxide (ReO₂, ReO₃, Re₂O₇, or ReOₓ), a palladium oxide (PdO or PdOₓ), and an iridium oxide (IrO₂ or IrOₓ). The substances can be used alone or in combination of two or more.

Examples of the metal complex include a phthalocyanine complex containing Cu, Re, Ru, Ni, Fe, Co, and Mn, a porphyrin complex, a pyridine complex, a metal-carrying covalent triazine structure, and the like.

Shapes of the elemental metal and the metal compound are not particularly limited as long as the effects of the present invention are not impaired, and the shapes are, for example, particulate or film-like. In addition, in the case of using the elemental metal and the metal compound as a catalyst, an effect of the catalyst increases as a surface area of the catalyst carried on the carrier increases, and thus a particulate form is preferable. Here, the particles are not limited to primary particles and may be secondary particles in which particles (primary particles) are aggregated. In addition, the term “particulate form” is not limited to a shape determined to be a particulate form based on the general technical knowledge and includes shapes in which particles are very small, and a coordinate-bonded metal which is called “monatomic particles” is highly dispersed at an atomic level.

An average particle size in a case where the elemental metal and the metal compound is particulate have the particulate form is not particularly limited as long as the effects of the technologies disclosed herein are not impaired, and the average particle size can be, for example, 1 to 200 nm, preferably 1 to 100 nm, and more preferably 1 to 50 nm. In the case of using the elemental metal and the metal compound as a catalyst, since the surface area of the catalyst increases as the particle size increases, an effect of an increase in the number of active spots (sites) where the catalyst contributes to a reaction is obtained. On the other hand, in addition to the effect of the surface area, the particle size of the catalyst also has an effect of greatly changing the activity and selectivity called size effects. Hence, the activity of the catalyst may be confirmed, and the particle size of the catalyst may be selected. Regarding the average particle size of the catalyst for a reduction reaction of carbon dioxide, the smaller the size, the more effect the size effect is, and in the technologies disclosed herein, the average particle size of the catalyst is preferably 100 nm or less, and more preferably 50 nm or less. In addition, it is preferable that the catalyst be not aggregated but dispersed, that is, more primary particles be contained, because the effect of the catalyst is high. Here, the average particle size of the elemental metal and the metal compound (catalyst) is an average particle size of primary particles of the elemental metal and the metal compound (catalyst). In the measurement of the average particle size, any rectangle having a length of 4.5 μm and a width of 6.0 μm in a secondary electron image confirmed under conditions of an acceleration voltage of 10 kV and a magnification of 20,000 times is set as a measurement range using a scanning electron microscope. The particles carried in all the composites without a part out of the measurement range are observed, a length in the longest direction of the appearing particles is measured, and an average value of the obtained long diameters is taken as the average particle size.

### 2. Method for Manufacturing Composite

The method for manufacturing a composite of the present disclosure will be described. According to the method for manufacturing a composite of the present disclosure, it is possible to obtain the composite in which at least one of an elemental metal or a metal compound having a smaller particle size and high dispersibility is caused to be carried on a carrier. The composite prepared by the method for manufacturing a composite in the present disclosure is more suitable as a composite in the method for manufacturing a slurry of the present disclosure to be described below.

Here, in a case where the composite prepared by the method for manufacturing a composite of the present disclosure is used in the method for manufacturing a slurry of the present disclosure, a “solvent” is replaced with a “solvent (B)”, and a “dispersion liquid” is replaced with a “second dispersion liquid”.

The method for manufacturing a composite of the present disclosure includes a pressure reducing step (S1-1) of exposing a dispersion liquid containing a solvent and a carrier to a reduced-pressure environment of less than 80 kPa (absolute pressure) at normal temperature, a raw material mixture liquid preparing step (S1-2) of preparing a raw material mixture liquid by mixing, with the dispersion liquid, a metal-ion supplying agent which supplies metal ions serving as raw materials of the elemental metal or the metal compound, and a carrying step (S1-3) of adding a reducing agent to the raw material mixture liquid and causing the elemental metal or the metal compound to be carried on a surface of the carrier.

In this manner, the prepared composite is taken out from the solvent, the solvent is removed by drying or the like, and thereby a composite suitable for being used in the method for manufacturing a slurry to be described below can be obtained.

Regarding the catalyst in which at least one of the elemental metal or the metal compound serving as the catalyst is caused to be carried on the carrier by using the method for manufacturing a composite of the present disclosure, as described above, the particle size of the catalyst carried on the surface of the carrier is decreased so that the catalyst is good in decreasing the particle size even as a carrying target (for example, used as an electrocatalyst) and is better in having high dispersibility:

2-1. Pressure Reducing step (S1-1)

In the pressure reducing step (S1-1), the dispersion liquid containing the solvent and the carrier is exposed to the reduced-pressure environment of less than 80 kPa (absolute pressure) at normal temperature.

In the pressure reducing step (S1-1), air bubbles are removed from the dispersion liquid so that the particle size of the composite (or the carrying target) itself can be decreased. This is because, as a result of removal of air bubbles that have been crystal nuclei in the dispersion liquid, local precipitation (generation) of the elemental metal or the metal compound is suppressed, uniformity of particles of the elemental metal or the metal compound is improved, and the particle size is decreased. As described above, an electrode, an ion-exchange membrane-electrode assembly, and a CO₂ electrolytic apparatus using the composite (or the carrying target) as an electrocatalyst can be good in generation efficiency of a reduction product.

The solvent is, for example, water or an alcohol compound, and that alcohol compound that is in a liquid phase in a temperature range of a preparing step and a reducing step under an atmospheric pressure is used. It is preferable to use a solvent in which a metal-ion supplying agent and a reducing agent can be dissolved. In this manner, an effect of sufficiently increasing a carrying amount of the catalyst can be obtained. A solvent having a vapor pressure lower than a pressure at which exposure is performed in the pressure reducing step is more preferable. In this manner, an effect of suppressing volatilization of the solvent during the pressure reducing step is achieved. Examples of the compound include water, methanol, ethanol, 1-propyl alcohol, 1-butyl alcohol, isopropanol, ethylene glycol, propylene glycol, diethylene glycol, and glycerin.

In the pressure reducing step (S1-1), the dispersion liquid obtained by mixing the solvent and the carrier is put in a vacuum container or a container installed in a vacuum chamber, a pressure inside the vacuum container or the container installed in the vacuum chamber is reduced to lower than 80 kPa (absolute pressure) at normal temperature by using a known pressure reduction method, and the dispersion liquid is exposed to a reduced-pressure environment. Air bubbles in the dispersion liquid can be removed by exposing the dispersion liquid to the reduced-pressure environment. Here, an exposure time can be 1 to 60 minutes.

In addition, as the pressure reduction method, for example, a known pressure reducing device such as an evaporator or a vacuum pump can be used. In addition, a dispersion liquid obtained by exposing at least one of the solvent and the carrier before mixing to a reduced-pressure environment of less than 80 kPa (absolute pressure) at normal temperature in advance can be used.

A pressure at the time of pressure reduction is less than 80 kPa (absolute pressure). This is preferable since the lower the ultimate pressure, the better the removal of air bubbles. However, if the ultimate pressure is too low, the solvent may boil, and thus the pressure is preferably 0.1 to 50 kPa and more preferably 5 to 10 kPa (absolute pressure). In a case where the ultimate pressure is in such a range described above, the particle size of the composite (or the carrying target) can be decreased.

A mixing ratio of the solvent and the carrier is not particularly limited as long as the effects of the technologies disclosed herein are not impaired, and for example, the mixing ratio can be set to 100:0.01 to 100:1 in terms of a mass ratio.

The dispersion liquid may contain a component other than the solvent and the carrier.

### 2-2. Raw Material Mixture Liquid Preparing Step (S1-2)

In the raw material mixture liquid preparing step (S1-2), a metal-ion supplying agent for supplying metal ions serving as the raw material of the elemental metal or the metal compound is mixed with the dispersion liquid to prepare a raw material mixture liquid. The performing of the raw material mixture liquid preparing step (S1-2) is not limited to a reduced-pressure environment, and the step can be performed under a normal pressure environment. In addition, the raw material mixture liquid preparing step (S1-2) can be performed after the pressure reducing step (S1-1) or can be performed simultaneously with the pressure reducing step (S1-1). That is, before the dispersion liquid is exposed to the reduced-pressure environment, the metal-ion supplying agent for supplying metal ions serving as the raw material of the elemental metal or the metal compound is mixed to prepare the raw material mixture liquid, and then the raw material mixture liquid can be exposed to the reduced-pressure environment of less than 80 kPa (absolute pressure) at normal temperature.

The metal-ion supplying agent is mixed with the dispersion liquid to form the raw material mixture liquid. The metal-ion supplying agent supplies metal ions into the raw material mixture liquid. The metal ions in the raw material mixture liquid form a composite by adding a reducing agent to the raw material mixture liquid in the carrying step (S1-3) to be described below to cause the elemental metal or the metal compound to be carried (precipitated) on the surface of the carrier. That is, the metal-ion supplying agent is a metal ion source of the elemental metal or the metal compound carried on the composite, that is, the metal-ion supplying agent is a raw material thereof.

In the present disclosure, the metal-ion supplying agent is not limited to a metal compound containing a desired metal and also includes a desired elemental metal. As the metal-ion supplying agent, an elemental metal: sulfate, nitrate, carbonate, acetate, oxide, hydroxide, fluoride, chloride, bromide, sulfide, composite salt, and the like can be used. More specifically, gold (I) chloride, gold (III) chloride, gold (III) tetrachloride acid, gold (III) bromide, potassium gold (I) cyanide, silver (I) nitrate, silver (I) cyanide, copper (II) sulfate, copper (II) nitrate, copper (II) carbonate, copper (I) acetate, copper (II) acetate, copper (II) citrate, copper (II) fluoride, copper (I) chloride, copper (II) chloride, copper (I) bromide, copper (II) bromide, platinum (II) chloride, platinum (IV) chloride, platinic acid (II) chloride, platinic acid (IV) chloride, platinum (II) bromide, and platinum (IV) bromide can be used. The substances can be used alone or in combination of two or more.

A mixing amount of the metal-ion supplying agent is not particularly limited as long as the effects of the technologies disclosed herein are not impaired: however, a carrying amount of the elemental metal or the metal compound on the carrier can be increased by reducing an injection amount of the carrier and/or increasing an injection amount of the metal-ion supplying agent in the raw material mixture preparing step (S1-2). For example, when the mixing amount of the carrier is 100 parts by mass, the injection amount of the metal-ion supplying agent as the elemental metal or the metal compound is preferably 65 parts by mass or more and 150 parts by mass or less and more preferably 75 parts by mass or more and 135 parts by mass or less. Further, the mixing amount is more preferably 75 parts by mass or more and 120 parts by mass or less. By setting the injection amount of the metal-ion supplying agent to 150 parts by mass or less, the contact probability between the metal ions or generated metal particles and the carrier can be very improved. In addition, by setting the injection amount to 65 parts by mass or more, the amount of the carrier with respect to the generated metal particles becomes appropriate, and a sufficient amount of a metal carrier or the metal compound can be caused to be carried.

In addition, the concentration of the metal ions supplied from the metal-ion supplying agent in the solvent is not particularly limited as long as the effects of the technologies disclosed herein are not impaired, and the concentration may be, for example, 0.1 to 2.0 g/L.

### 2-3. Carrying Step (S1-3)

In the carrying step (S1-3), the reducing agent is added to the raw material mixture liquid prepared in the raw material mixture liquid preparing step (S1-2), metal ions in the raw material mixture liquid are reduced, and the metal ions are precipitated (carried) as the elemental metal or the metal compound on the surface of the carrier to form a composite. The metal compound is precipitated as a metal oxide bonded to dissolved oxygen in the raw material mixture liquid. A generation ratio of precipitation of the elemental metal and the metal compound can be controlled by adjusting a dissolved oxygen concentration of a liquid phase mixture.

In the carrying step (S1-3), first the concentration of oxygen dissolved in the liquid phase mixture can be adjusted based on a ratio of the elemental metal and the metal compound that are desired to be carried on the carrier. The dissolved oxygen concentration can be controlled by bubbling a predetermined gas. For example, in a case where it is desired to lower an oxygen partial pressure, bubbling of an oxygen-free gas such as an N₂ gas is performed. Conversely, when it is desired to increase the oxygen partial pressure, bubbling of an oxygen-containing gas such as an O₂ gas or air is performed.

After the dissolved oxygen concentration is adjusted as desired, the liquid phase mixture is heated to a target temperature corresponding to a predetermined metal by a heating device (not illustrated), and the raw material mixture liquid is agitated at a rotation speed for a predetermined time so that a reduction reaction proceeds. The target temperature can be appropriately changed depending on metal cations or the like to be reduced.

In a case where the metal cation to be reduced is a copper ion, the target temperature may be 40° C. or higher, 50° C. or higher, or 60° C. or higher. In a case where the metal cation to be reduced is another metal ion (e.g. a platinum ion, a gold ion, or a silver ion), the target temperature may be 5° C. or higher, 15° C. or higher, or 20° C. or higher.

On the other hand, the target temperature is preferably lower than 100° C., 90° C. or lower, 80° C. or lower, 70° C. or lower, or 65° C. or lower. Excessive heating is disadvantageous in terms of input energy. According to the method of the present invention, the reduction reaction sufficiently proceeds even at a temperature of less than 100° C. In addition, in the present invention, a sufficient reduction and precipitation occur even at a low temperature, but excessive heating causes an excessive reduction reaction and causes aggregation of particles, and thus it may be difficult to control the particle size.

The time required for a reduction step depends on various conditions, but is usually 0.1 to 24 hours or 0.5 to 4 hours.

The reducing agent is not particularly limited as long as the effects of the technologies disclosed herein are not impaired, and examples thereof include phosphinic acid salts. Examples of the phosphinic acid salts include lithium phosphinate, sodium phosphinate, potassium phosphinate, and ammonium phosphinate. The substances can be used alone or in combination of two or more.

A mixing amount of the reducing agent is not particularly limited as long as the effects of the technologies disclosed herein are not impaired, and for example, a mixing ratio (Er/Ec) of a reduced metal ion equivalent (Er) of the reducing agent to a metal ion equivalent (Ec) of the metal-ion supplying agent can be 0.5 or more and is preferably 1.0 or more, more preferably 1.2 or more, and still more preferably 1.5 or more. The upper limit value of the mixing ratio is not particularly limited: however, Er/Ec can be set to 5.0 or less from the viewpoint of manufacturing cost, for example. In addition, the mixing amount of the reducing agent can be, for example, 1 to 10 g/L with respect to the raw material mixture liquid.

### 3. Method for Manufacturing Slurry

The method for manufacturing a slurry of the present disclosure is a method for manufacturing a slurry containing a polymer material and a composite in which at least one of an elemental metal or a metal compound is caused to be carried on a carrier.

The method for manufacturing a slurry includes a pressure reducing step (S2-1) of exposing a first dispersion liquid containing a solvent (A) and the composite to a reduced-pressure environment of less than 80 kPa (absolute pressure) at normal temperature, and a slurry preparing step (S2-2) of preparing a slurry by mixing the polymer material with the first dispersion liquid. According to the method, since a slurry can be prepared without performing a redundant treatment at a high temperature and a high pressure (for example, treatment at 200° C. or higher and 20 atm or higher), it is possible to prevent degeneration of a catalyst (an elemental metal or a metal compound) and a resin in a case where the composite is coated with an ion-exchange resin to be described below. In addition, there is an advantage in that manufacturing can be performed at low costs without performing a high-temperature and high-pressure process.

### 3-1. Pressure Reducing Step (S2-1)

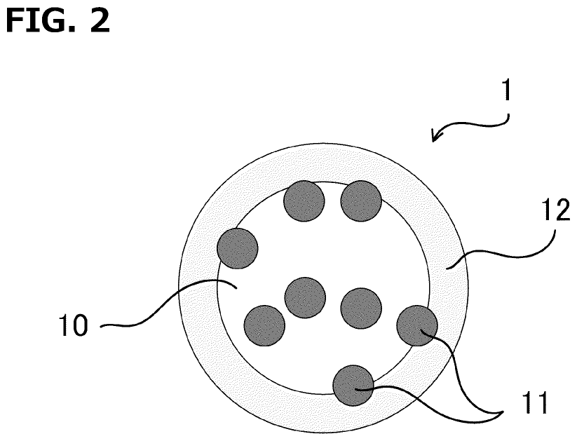

In the pressure reducing step (S2-1), a first dispersion liquid obtained by mixing a solvent (A) and the composite is put in a vacuum container or a container installed in a vacuum chamber, a pressure inside the vacuum container or the container installed in the vacuum chamber is reduced to lower than 80 kPa (absolute pressure) at normal temperature by using a known pressure reduction method, and the first dispersion liquid is exposed to a reduced-pressure environment. Consequently, air bubbles are removed from the first dispersion liquid. Therefore, when the slurry is sprayed on a base material by a spray or the like and the solvent (A) is removed by drying or the like, it is possible to form (co-carry with the elemental metal or the metal compound) a coating layer in which a part or the whole of a surface of the composite is uniformly coated with a polymer material. That is, as a result of removing the air bubbles in the first dispersion liquid (or the raw material mixture liquid), the remaining of the air bubbles on a composite-polymer material interface is suppressed, the uniformity of the coating layer of the polymer material is improved, and a stable coating layer is formed. As described above, an electrode, an ion-exchange membrane-electrode assembly, and a CO₂ electrolytic apparatus using, as an electrode catalyst, the composite (see FIG. 2, hereinafter, referred to as a polymer coated composite or a polymer coated composite in some cases) having a coating layer in which the polymer material is used as an ion-exchange resin can be excellent in generation efficiency of a reduction product. Here, an exposure time can be 1 to 60 minutes.

In addition, as the pressure reduction method, for example, a known pressure reducing device such as an evaporator or a vacuum pump can be used. In addition, a dispersion liquid obtained by exposing at least one of the solvent (A) and the carrier before mixing to a reduced-pressure environment of less than 80 kPa (absolute pressure) at normal temperature in advance can be used.

A pressure at the time of pressure reduction is less than 80 kPa (absolute pressure). This is preferable since the lower the ultimate pressure, the better the removal of air bubbles. However, if the ultimate pressure is too low; the solvent (A) may boil, and thus the pressure is preferably 0.1 to 50 kPa and more preferably 5 to 40 kPa (absolute pressure). When the ultimate pressure is in such a range described above, the coating layer of the polymer coated composite can be made uniform.

A mixing ratio (mass ratio) of the solvent (A) and the composite is not particularly limited as long as the effects of the technologies disclosed herein are not impaired, and for example, the mixing ratio can be set to 10,000:1 to 1:1.

The first dispersion liquid may contain a component other than the solvent (A) and the carrier.

### 3-1-1. Composite Used in Method for Manufacturing Slurry

The method for manufacturing a composite used in the method for manufacturing a slurry of the present disclosure is not particularly limited as long as the effects of the technologies disclosed herein are not impaired. As the method for manufacturing a composite used in the method for manufacturing a slurry, a known mixer is used to mix a carrier and an elemental metal or a metal compound to prepare a carrier (hereinafter, referred to as a carrying target in some cases) carried on the elemental metal or the metal compound. The mixing time in this case can be 3 to 60 minutes.

As another method of preparing the carrying target, a method of precipitating the elemental metal or the metal compound on the carrier through a reduction reaction can be provided. More specifically, a catalytic metal can be caused to be carried on a conductive carrier by mixing a carrier, a metal-ion supplying agent for supplying a metal ion serving as a raw material of the elemental metal or the metal compound, and a reducing agent, and reducing a metal cation. The mixing time in this method can be 1 to 48 hours. According to this method, it is preferable to enable the elemental metal or the metal compound having a smaller particle size to be carried on a carrier.

As a more preferred method for manufacturing a composite used in the method for manufacturing a slurry is the above-described method for manufacturing a composite of the present disclosure, including a pressure reducing step (S1-1) of exposing a second dispersion liquid containing a solvent (B) and the carrier to a reduced-pressure environment of less than 80 kPa (absolute pressure) at normal temperature, a raw material mixture liquid preparing step (S1-2) of preparing a raw material mixture liquid by mixing, with the dispersion liquid, a metal ion supplying agent which supplies metal ions that become raw materials of the elemental metal or the metal compound, and a carrying step (S1-3) of adding a reducing agent to the raw material mixture liquid and causing the elemental metal or the metal compound to be carried on a surface of the carrier.

According to the method, it is possible to obtain the composite in which at least one of an elemental metal or a metal compound having a smaller particle size and high dispersibility is caused to be carried on a carrier.

### 3-1-2. Solvent (A)

As the solvent (A), water or an alcohol compound that is in a liquid phase in a temperature range of the pressure reducing step under atmospheric pressure is used. A solvent having a vapor pressure lower than a pressure at which exposure is performed in the pressure reducing step is more preferable. In this manner, an effect of suppressing volatilization of the solvent during the pressure reducing step is achieved. Examples of the compound include water, methanol, ethanol, 1-propyl alcohol, 1-butyl alcohol, isopropanol, ethylene glycol, propylene glycol, diethylene glycol, and glycerin.

A mixing ratio (mass ratio) of the solvent (A) and the carrier is not particularly limited as long as the effects of the technologies disclosed herein are not impaired, and for example, the mixing ratio can be set to 10,000:1 to 1:1.

### 3-2. Slurry Preparing Step (S2-2)

In the slurry preparation step (S2-2), a polymer is mixed with the first dispersion liquid to prepare a slurry. The performing of the slurry preparing step (S2-2) is not limited to a reduced-pressure environment, and the step can be performed under a normal pressure environment. In addition, the slurry preparing step (S2-2) can be performed after the pressure reducing step (S2-1) or can be performed simultaneously with the pressure reducing step (S2-1). That is, before the first dispersion liquid is exposed to the reduced-pressure environment, the polymer is mixed to prepare a slurry, and then the slurry can be exposed to a reduced-pressure environment of less than 80 kPa (absolute pressure) at normal temperature.

The mixing amount of the polymer is not particularly limited as long as the effects of the technologies disclosed herein are not impaired: however, when the mixing amount of the composite is 100 parts by mass, for example, the mixing amount of the polymer can be 1 to 100 parts by mass %.

Regarding the polymer according to the present disclosure, when the slurry prepared by the method for manufacturing a slurry of the present disclosure is sprayed on a base material by a spray or the like, and the solvent (A) is removed by drying or the like, a coating layer with which a part or the whole of a surface of the composite is coated can be formed (co-carried with the elemental metal or the metal compound).

A material of the polymer is not particularly limited as long as the effects of the technologies disclosed herein are not impaired. In a case where a polymer coated carrying target is used as an electrocatalyst, it is preferable to use an ion-exchange resin, and in particular, when an anion-exchange resin is used, an electrocatalyst capable of adsorbing a large amount of CO₂ can be obtained, and a good production efficiency of reduction products such as CO (carbon monoxide) can be achieved in CO₂ reduction.

The anion-exchange resin according to the present disclosure is preferably an ionomer containing an amino group or a quaternary ammonium group. That is, the anion-exchange resin preferably has a structure in which a structure having an amino group or a quaternary ammonium group is added to a base resin of the ionomer. Here, the amino group includes a primary amino group, a secondary amino group, and a tertiary amino group.

A base point density of the anion-exchange resin (ionomer) is 2.0 mmol/cm³ or higher and 5.0 mmol/cm³ or lower, preferably 2.5 mmol/cm³ or higher and lower than 4.5 mmol/cm³, and more preferably 2.9 mmol/cm³ or higher and lower than 4.5 mmol/cm³. In a case where the base point density of the anion-exchange resin is in such a range described above, an electrocatalyst having a good CO₂ reduction efficiency can be obtained even in a case where a CO₂ concentration in the periphery of the electrocatalyst is low.

In a case where the carrying target is not coated with the anion-exchange resin or even in a case where the carrying target is coated with the anion-exchange resin, CO₂ supplied to the electrocatalyst is a gas so that the CO₂ can freely move, an opportunity for the CO₂ to be adsorbed to active spots of the catalyst is limited, and the CO₂ reduction efficiency is also limited, in a case where the base point density of the anion-exchange resin is low:

On the other hand, in a case where the carrying target is coated with the anion-exchange resin and the base point density of the anion-exchange resin is higher than a certain level (a case where the base point density is 2.0 mmol/cm³ or higher), CO₂ as a weak acid incorporated into the coating can be neutralized by a base point of the anion-exchange resin and can remain in the anion-exchange resin mainly as hydrogen carbonate ions (HCO₃⁻) or carbamate ester (carbamate). As a result, the hydrogen carbonate ions are abundantly accumulated in the vicinity of the catalyst carried on the carrying target. In this manner, the hydrogen carbonate ions become CO₂ through an equilibrium reaction, and thereby CO₂ can be efficiently adsorbed to the active spots of the catalyst. Consequently, the CO₂ reduction efficiency of the electrode material can be improved. This effect is also effective even in a case where the concentration of CO₂ to be supplied is high and is more effective in a case where the concentration of CO₂ to be supplied is low.

In addition, in a case where the base point density exceeds 5.0 mmol/cm³, the hydrophilicity increases. Hence, swelling due to water (H₂O) generated during the above-described neutralization reaction proceeds, and mechanical characteristics of the catalyst as the electrocatalyst may deteriorate.

The base point density of the anion-exchange resin can be adjusted by a ratio of a hydrophobic structure and a hydrophilic structure in a molecular structure of the ionomer. Therefore, as a method of adjusting the base point density of the anion-exchange resin, the base point density can be adjusted by copolymerizing a monomer having a hydrophobic structure or a polymer obtained by polymerizing a monomer in advance and a monomer having a hydrophilic structure or a polymer obtained by polymerizing a monomer in advance by adjusting a mixing ratio thereof.

The base point density of the anion-exchange resin is obtained from a value of integral of signals of an amino group, a quaternary ammonium group, and other functional groups serving as base points by ¹H-NMR measurement.

The base resin of the ionomer is not particularly limited as long as the effects of the technologies disclosed herein are not impaired, and for example, copolymers obtained by copolymerizing an ethylene-based monomer, a styrene-based monomer, a urethane-based monomer, a halogen-based monomer, and polymers obtained by polymerizing these monomers in advance can be used. As these copolymers, any of random copolymers, block copolymers, graft copolymers, alternating copolymers, and the like can be used. In addition, these copolymers can be used alone or in combination of two or more.

Since the ionomers according to the present disclosure have an amino group or a quaternary ammonium group, but these ionomers are hydrophilic groups, it is preferable to use the ionomers by adding the ionomers to a monomer or a polymer in advance for use in order to adjust the base point density. In addition, as a hydrophobic monomer or polymer to be added in order to adjust the base point density, a halide-based monomer, an aromatic monomer, a monomer containing an ether bond, or a polymer thereof can be used from the viewpoint of high hydrophobicity, and in particular, a fluorine-based monomer is preferably used.

The anion-exchange resin (the same applies to the case of the polymer) coats a part or the whole of the surface of the carrying target, and a coverage θ, which is a ratio of a coated area to a surface area of the carrying target, can be 70% or more, 80% or more, 90% or more, 95% or more, or 100%. The coverage θ is preferably high from the viewpoint of the effect of accumulating a large amount of CO₂ in the vicinity of the catalyst. Here, the coverage θ is expressed by the following Expression 1 with respect to electric double-layer capacitance C_{d1/i} in a dry state and electric double layer capacitance C_{d1/W} in a wet state of the electrode, which are calculated by electrochemical impedance measurement under an inert gas atmosphere.

$$θ = ( {C}_{dl / i} / {C}_{dl / w} ) \times 100 \qquad ( Expression 1 )$$

Here, an equivalent circuit is a circuit including a capacitor and a resistor (A) in parallel and a resistor (B) connected in series thereto, and the capacitance when the electrode of the capacitor is in a dry state is represented by C_{d1/i}, and the capacitance when the electrode of the capacitor is in a wet state is represented by C_{d1/w}. Here, the case where the electrode of the capacitor is in the dry state indicates a case where the measurement is performed in an environment where the relative humidity is less than 10% or a case where a moisture content of a raw material gas to be supplied is 0.5 volume % or less (the volume % of the entire raw material gas is set to 100 volume %), and the case where the electrode of the capacitor is in the wet state indicates a case where the measurement is performed in an environment where the relative humidity is 100%. Other details regarding the measurement of the coverage will follow the method described in Journal of Electroanalytical Chemistry Volume 693, Mar. 15, 2013, Pages 34-41.

Here, the coverage θ can further increase when the anion-exchange resin (or the polymer) and the carrying target are mixed, or when the anion-exchange resin and the carrying target are exposed to a more significantly reduced-pressure environment (under a lower pressure) after being mixed.

An average coating thickness of the anion-exchange resin is not particularly limited as long as the effects of the technologies disclosed herein are not impaired, and the average coating thickness may be, for example, 0.01 to 100 μm.

When the average coating thickness of the anion-exchange resin is 0.01 μm or more, a channel for ion conduction is sufficiently formed, and hydroxide ions (OH) generated by a reaction can be more efficiently transported to the ion-exchange membrane. Further, a basic point amount is sufficient, and thus a retention amount of carbonate species such as CO₂ or hydrogen carbonate ions is sufficient.

In addition, when the average coating thickness of the anion-exchange resin is 100 μm or less, an appropriate distance by which ions have to move is obtained so that appropriate resistance against movement of ions is generated, and an increase in voltage can be suppressed (suppression of a decrease in efficiency). Further, since the distance by which CO₂ has to diffuse to reach a catalyst is not too long, the movement of CO₂ becomes easy, and an increase in voltage can be suppressed (suppression of a decrease in efficiency).

As described above, when the average coating thickness of the anion-exchange resin is in such a range described above, a generation efficiency for producing a reduction product (CO or the like) from CO₂ is good, and particularly in a case where a supply concentration of CO₂ is low; an electrode material having a better generation efficiency of the reduction product can be obtained.

### 4. Applications of Slurry

The slurry obtained by the method of the present disclosure is sprayed by a spray or the like, and the solvent (A) is removed by drying or the like, and thereby a polymer coated composite can be formed in which the surface of the composite in which at least one of the elemental metal or the metal compound is caused to be carried on the carrier is coated with a polymer. As described above, the electrocatalyst can be formed by using a catalyst as the elemental metal or the metal compound, using a conductive carrier as a carrier, and further using an anion-exchange resin as a polymer. The electrocatalyst obtained as described above is better in that the electrocatalyst is good in reducing the particle size and has high dispersibility. Therefore, the electrode using the electrocatalyst can be good in the generation efficiency of the reduction product. In addition, this electrode can be bonded to an ion-exchange membrane to form an ion-exchange membrane-electrode assembly and can be used for a CO₂ electrolytic apparatus.

### 4-1. Ion-Exchange Membrane-Electrode Assembly

When the membrane-electrode assembly is formed using the electrode material of the present disclosure, the membrane-electrode assembly having high CO₂ reduction efficiency can be obtained.

The ion-exchange membrane-electrode assembly of the present disclosure is mainly configured to include the electrocatalyst, the ion-exchange membrane, and a current collector (also referred to as a current collecting plate when used in a plate shape) according to the present disclosure. In addition, the electrocatalyst of the present disclosure is provided and used between the ion-exchange membrane and the current collector. The electrocatalyst can be attached to a base material to form an electrode having a desired shape.

### 4-1-1. Ion-Exchange Membrane

The ion-exchange membrane according to the present disclosure is not particularly limited as long as the effects of the technologies disclosed herein are not impaired, and examples thereof include cation-exchange membranes such as Nafion (registered trademark) and Aquivion (registered trademark) or anion-exchange membranes such as Sustainion (registered trademark) and Fumasep (registered trademark). The anion-exchange membranes are preferably used. In addition, in the ion-exchange membrane-electrode assembly of the present disclosure, it is particularly preferable to use an anion-exchange membrane in which a primary amino group, a secondary amino group, a tertiary amino group, a quaternary ammonium group, and a plurality of these ion-exchange groups are mixed. Specific examples of the ion-exchange membranes can include Neosepta (registered trademark), ASE, AHA, AMX, ACS, AFN, AFX (manufactured by Tokuyama Corporation), Selemion (registered trademark), AMV, AMT, DSV, AAV, ASV, AHO, AHT, APS4 (manufactured by Asahi Glass Co., Ltd.) and the like can be used.

A material of the anion-exchange membrane may be the same as or different from the material of the ion-exchange resin which is a polymer for coating the electrocatalyst of the present disclosure. In a case where the material of the anion-exchange membrane is the same as the material of the anion-exchange resin with which the electrocatalyst of the present disclosure is coated, it is possible to avoid alteration of an interface between the anion-exchange resin and the anion-exchange membrane, and it is preferable that the ions can smoothly move (be conductive) by avoiding phase separation of the interface between the anion-exchange resin and the anion-exchange membrane.

### 4-1-2. Current Collector

Examples of the current collector according to the present disclosure include metal materials such as copper (Cu), nickel (Ni), stainless steel (SUS), nickel-plated steel, and brass, and of the materials, copper is preferable from the viewpoint of ease of processing and cost. In a case where the current collector is made of a metal material, examples of a shape of a negative-electrode current collector include a metal foil shape, a metal plate shape, a metal thin film shape, an expanded metal shape, a punching metal shape, and a foamed metal shape.

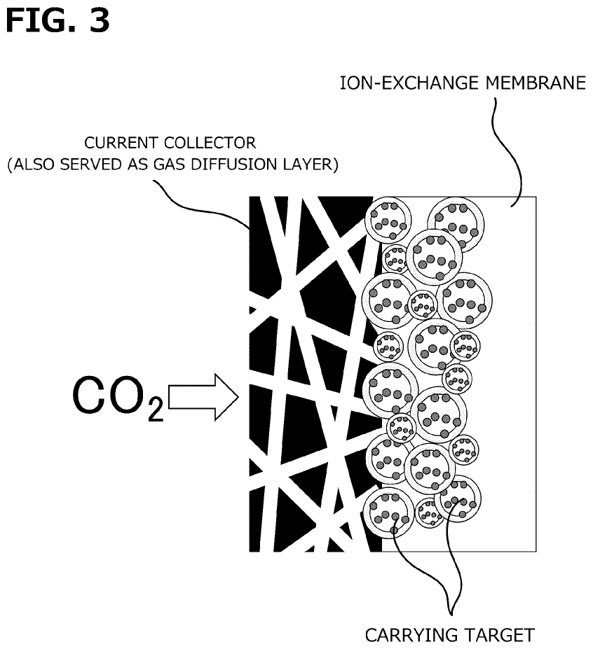

Here, the current collector has air holes provided to supply and collect a gas (raw material gas or generated gas) to and from the electrode (or the electrocatalyst). These air holes enable the raw material gas to be uniformly and efficiently fed to the electrode (or the electrocatalyst) and the generated gas (including an unreacted raw material gas) to be discharged. The number, positions, and size of the air holes are not limited and are appropriately set. Additionally, in a case where the current collector has an aeration property, the air holes are unnecessary. FIG. 3 illustrates an explanatory view of the ion-exchange membrane-electrode assembly, and the current collector in FIG. 3 is made of a porous material having the aeration property.

### 4-2. CO₂ Electrolytic Apparatus

The electrocatalyst and the ion-exchange membrane-electrode assembly according to the present disclosure are used as a cathode, and thereby it is possible to obtain a CO₂ electrolytic apparatus that is good in CO₂ reduction efficiency and is more effective particularly in a case where the concentration of CO₂ to be supplied is low: The CO₂ electrolytic apparatus can be used, for example, in a method for manufacturing a CO₂ electrolytic product such as CO.

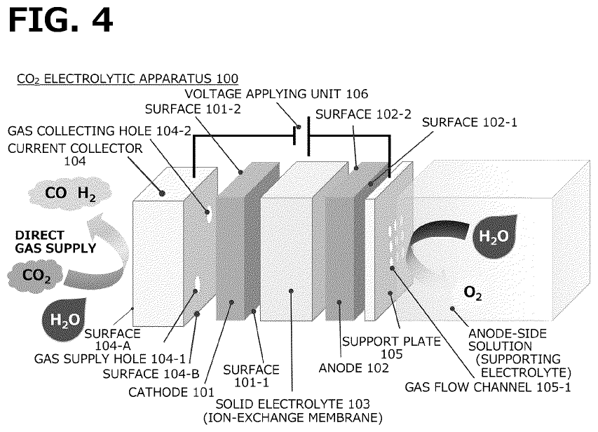

An example of the CO₂ electrolytic apparatus of the present disclosure will be described with reference to FIG. 4. The CO₂ electrolytic apparatus includes a cathode 101, an anode 102 constituting a pair of electrodes with the cathode 101, a solid electrolyte 103 interposed between the cathode 101 and the anode 102 in a state where at least a part of the solid electrolyte is in contact with the cathode and the anode, a current collector 104 in contact with a surface 101-2 of the cathode 101 on a side opposite to a contact surface 101-1 in contact with the solid electrolyte 103, a support plate 105 in contact with a surface 102-1 of the anode 102 on a side opposite to a contact surface 102-2 in contact with the solid electrolyte 103, and a voltage applying unit 106 that applies a voltage between the current collector 104 and the support plate 105 (that is, between the cathode and the anode). In addition, CO₂ in a gas phase state or an aqueous electrolyte solution such as H₂O or KHCO₃ which is a supporting electrolyte is supplied by a supply source and a supply device (not illustrated). Although the CO₂ electrolytic apparatus 100 illustrated in FIG. 4 is illustrated in a state where components such as the cathode 101 and the anode 102 are separated for the sake of description, actually, the current collector 104, the cathode 101, the solid electrolyte 103, the anode 102, and the support plate 105 are configured to be individually bonded by a predetermined method and integrated. The individual components can be detachably configured to constitute one CO₂ electrolytic apparatus 100.

Here, the electrocatalyst according to the present disclosure is used as the cathode 101.

In addition, the ion-exchange membrane-electrode assembly of the present disclosure serves as the current collector 104, the cathode 101, and the solid electrolyte 103 in FIG. 4. That is, the current collector constituting the ion-exchange membrane-electrode assembly becomes the current collector 104, the electrocatalyst of the present disclosure becomes the cathode 101, the anion-exchange membrane constitutes the solid electrolyte 103, and thereby an integrated cathode can be formed.

### EXAMPLES

Next, the technologies disclosed herein will be described in detail with reference to Examples and Comparative Examples, but the technologies disclosed herein are not limited thereto at all.

### <<Preparation of Composite>>

### Example 1

In a beaker, 0.3 g of carbon black (carrier) was mixed with 100 mL of ethanol (solvent (B)), and a mixture was subjected to ultrasonic treatment for 10 minutes and then exposed for 10 minutes in a vacuum chamber having a reduced-pressure environment of 10 kPa (absolute pressure). Thereafter, 11.7 mL of a 0.1 mol/L silver nitrate solution (metal-ion supplying agent) and 1 mL of a 2.3 mol/L sodium phosphinate solution (reducing agent) were mixed, and a mixture was agitated at room temperature for 8 hours to reduce silver nitrate. After completion of a reaction, an obtained slurry was washed with distilled water, collected by a centrifuge, and vacuum-dried at 60° C. for 12 hours to obtain a silver catalyst powder (composite).

### Example 2

A silver catalyst powder was prepared through the same process as in Example 1 except that the amount of carbon black to be mixed with ethanol was changed to 0.15 g.

### Example 3

A silver catalyst powder was prepared in the same process as in Example 1 except that the amount of carbon black to be mixed with ethanol was changed to 0.1 g.

### Example 4

A silver catalyst powder was prepared in the same process as in Example 1 except that the amount of carbon black to be mixed with ethanol was changed to 0.075 g.

### Comparative Example 1

A silver catalyst powder was prepared in the same process as in Example 1 except that the amount of carbon black to be mixed with ethanol was changed to 0.6 g, and exposure in a reduced-pressure environment was not performed.

### Comparative Example 2

A silver catalyst powder was prepared in the same process as in Example 1 except that exposure in a reduced-pressure environment was not performed.

### <<Measurement of Carrying Amount and Average Particle Size of Elemental Metal or Metal Compound in Composite>>

### <Measurement of Carrying Amount of Elemental Metal or Metal Compound>

For the obtained composites of Examples and Comparative Examples, a plurality of composites were subjected to X-ray fluorescence analysis, and a mass % of silver contained in the composite was obtained using a calibration curve prepared by performing, in advance, the same measurement as that on a powder having a carrier and a metal content which are already known.

### <Measurement of Average Particle Size of Elemental Metal or Metal Compound>

For the obtained composites of Examples and Comparative Examples, a rectangle having a length of 4.5 μm and a width of 6.0 μm in a secondary electron image confirmed under conditions of an accelerating voltage of 10 kV and a magnification of 20,000 times was set as a measurement range, silver particles carried on all the composites without a part out of the measurement range were observed using a scanning electron microscope (JSM-7001F manufactured by JEOL Ltd), and the length in the longest direction of the appearing silver particles was measured as a long diameter. The obtained values of the long diameter were averaged and arranged in 2 significant digits according to JIS Z 8401: 2019. The results of the average particle size of the silver particles are illustrated in Table 1. In addition, it is presumed that the elemental metals or the metal compounds of individual Examples did not have local generation of crystal nuclei (dispersibility was high) due to the absence of air bubbles, and the average particle size thereof could be reduced.

TABLE 1

| | | | Injection | Silver | Average |
|---|---|---|---|---|---|
| | Pressure | Injection | Amount of | Carrying | Particle |
| | Reducing | Amount of | Silver to | Mass | Size |
| | Treatment | Carrier (g) | Carrier (g) | (mass %) | (nm) |
| Example 1 | Performed | 0.300 | 0.126 | 9 | 47 |
| Example 2 | Performed | 0.150 | 0.126 | 27 | 50 |
| Example 3 | Performed | 0.100 | 0.126 | 25 | 45 |
| Example 4 | Performed | 0.075 | 0.126 | 28 | 51 |
| Comparative | Unperformed | 0.600 | 0.126 | 8 | 63 |
| Example 1 | | | | | |
| Comparative | Unperformed | 0.300 | 0.126 | 14 | 58 |
| Example 2 | | | | | |

### <<Preparation of Composite>>

### Example 5

In a beaker, 0.6 g of carbon black (carrier) was mixed with 100 mL of ethanol (solvent (B)), and a mixture was subjected to ultrasonic treatment for 10 minutes and then exposed for 10 minutes in a vacuum chamber having a reduced-pressure environment of 10 kPa (absolute pressure). Thereafter, 11.7 mL of a 0.1 mol/L silver nitrate solution (metal-ion supplying agent) and 1 mL of a 2.3 mol/L sodium phosphinate solution (reducing agent) were mixed, and a mixture was agitated at room temperature for 16 hours to reduce silver nitrate. After completion of a reaction, an obtained slurry was washed with distilled water, collected by a centrifuge, and vacuum-dried at 60° C. for 12 hours to obtain a silver catalyst powder (composite).

### Example 6

A silver catalyst powder (composite) was obtained by the same procedure as in Example 5 except that the silver catalyst powder was not exposed to a reduced-pressure environment at the time of composite synthesis.

### Example 7

A silver catalyst powder (composite) was obtained by the same procedure as in Example 5 except that the pressure in the reduced-pressure environment was 30 kPa (absolute pressure) in the composite synthesis.

### Example 8

A silver catalyst powder (composite) was obtained by the same procedure as in Example 5 except that the pressure in the reduced-pressure environment was 60 kPa (absolute pressure) in the composite synthesis.

### Comparative Example 3

A silver catalyst powder (composite) of Comparative Example 3 was obtained in the same process as in Example 5 except that exposure in the reduced-pressure environment was not performed in the composite synthesis.

### <<Preparation of Slurry and Preparation of Electrode>>

### Examples 5 to 8

Using the obtained composites of Examples 5 to 8, slurries of Examples 5 to 8 were prepared in the following procedure, and then electrodes of Examples 5 to 8 were further prepared.

15 mL of ethanol (solvent (A)) and 0.02 g of the obtained composite were mixed in a beaker, and further, 0.01 g of an ionomer (an anion-exchange resin that is a resin having a base point density of 2.9 mmol/cm³ and an aromatic group as a base material in the main chain, in which a quaternary ammonium group (quaternary alkylamine group) is bonded as a side chain to the main chain) powder as a polymer was mixed and exposed for 10 minutes in a vacuum chamber under a reduced-pressure environment of 10 kPa (absolute pressure) to prepare a slurry. Thereafter, the obtained slurry was applied on carbon paper under atmospheric pressure and dried to prepare an electrode.

### Comparative Example 3

A slurry and an electrode of Comparative Example 3 were obtained in the same process as in Examples 5 to 8 except that exposure in the reduced-pressure environment was not performed at the time of ionomer mixing.

### <<Evaluation>>

### <Configuration of CO₂ Electrolytic Apparatus>

The obtained electrodes of each of Examples and Comparative Examples was used as a cathode, and a titanium mesh carrying iridium oxide was used as an anode. In addition, an anion-exchange membrane having an ion exchange capacity of 1.5 mmol/g and a thickness of 30 to 35 μm was used as a solid electrolyte. An electrolytic solution tank (0.5M KHCO₃ aqueous solution) was used as a solution on the anode side. A cathode, a solid electrolyte, an anode, and an electrolytic solution tank were arranged in this order to form a structure in which the cathode and the electrolytic solution tank sandwiched the ion-exchange membrane and the anode.

### <Measurement of Ionomer Coverage>

CO₂ was supplied to the cathode by using this apparatus, an applying potential of the cathode was set to −0.2 V to a silver/silver chloride reference electrode, and the coverage θ with the ionomer was calculated using electrochemical impedance measurement. In the calculation, the electric double-layer capacitance C_{d1/i} of the cathode in a dry state measured under the supply of N₂ and the electric double-layer capacitance C_{d1/w} of the cathode in a wet state measured under the supply of CO₂ bubbled in ion-exchange water were calculated based on the following Expression 1.

### Expression 1

$$θ = ( {C}_{dl / i} / {C}_{dl / w} ) \times 100$$

It was presumed that an equivalent circuit is a circuit including a capacitor and the resistor (A) in parallel and the resistor (B) connected in series thereto, and the capacitance when the electrode of the capacitor is in a dry state is represented by C_{d1/i}, and the capacitance when the electrode of the capacitor is in a wet state is represented by C_{d1/w}. The results are illustrated in Table 3. The coverage of Example 6 was the same as that of Example 5.

### <Measurement of CO Generation Partial Current Density>

Using this apparatus, a gas mixed at a volume ratio of CO₂: N₂=3:1 was supplied to the cathode, an applying potential of the cathode was −1.8 V to a silver/silver chloride reference electrode, CO₂ was electrolyzed, and a CO generation partial current density [mA/cm²] in generating CO was measured. The results are illustrated in Tables 2 and 3. According to the results, it is presumed that in a case where a pressure reducing treatment at the time of mixing the ionomers was performed, air bubbles in the slurry were removed, and thus no air bubbles were present at an interface between the ionomer with which the surface of the composite was coated and the carrier (including silver particles). In this manner, a more uniform coating layer was formed and thus a good effect on the reduction efficiency (CO generation partial current density) was expected to be achieved. Further, the more remarkable the effect was, the lower the pressure during the pressure reducing treatment was.

TABLE 2

| | Pressure Reducing | | CO Generation |
|---|---|---|---|
| | Treatment During | Pressure Reducing | Partial Current |
| | Adjustment of | Treatment During | Density |
| | Composite | Ionomer Mixing | [mA/cm²] |
| Example 5 | Performed | Performed | 140 |
| Example 6 | Unperformed | Performed | 120 |
| Comparative | Unperformed | Unperformed | 110 |
| Example 3 | | | |

TABLE 3

| | Pressure Reducing | | CO Generation Partial |
|---|---|---|---|
| | Treatment During | | Current Density |
| | Ionomer Mixing | Coverage | [mA/cm2] |
| Example 5 | Performed (10 kPa) | 100% | 140 |
| Example 7 | Performed (30 kPa) | 100% | 140 |
| Example 8 | Performed (60 kPa) | 99% | 130 |
| Comparative | Unperformed | 91% | 110 |
| Example 3 | | | |

### <<Preparation of Composite Carrying Nickel Monatomic Particles>>

In a beaker, 15 mL of ethanol was mixed with 0.4 g of carbon black (carrier), 1.1 mmol of pentaethylenehexamine, and 0.7 mmol of nickel (II) chloride hexahydrate, and the obtained ethanol dispersion liquid was irradiated with ultrasonic waves for 10 minutes. Thereafter, the ethanol dispersion liquid was heated and dried to evaporate ethanol, and the obtained mixture was heated and fired in an inert gas at 900° C. for 30 seconds or more using an electric furnace. Thereafter, a product was washed with an aqueous sulfuric acid solution, and a solid was collected by a suction filter and vacuum-dried at 60° C. for 12 hours to obtain a catalyst powder (composite) on which an Ni complex was carried. This catalyst powder was used as a catalyst powder of Example 9 and Comparative Example 4.

In the obtained catalyst powder, a mass of carried Ni was 1 part by mass with respect to 100 parts by mass of carbon black as the carrier.

### <<Preparation of Slurry and Preparation of Electrode>

### Example 9

In a beaker, 15 mL of ethanol and 0.02 g of the obtained composite were mixed, and further, an ionomer (“Nafion (registered trademark)” cation-exchange resin manufactured by Sigma-Aldrich Co. LLC) as a polymer was mixed and exposed for 10 minutes in a vacuum chamber under the reduced-pressure environment of 10 kPa (absolute pressure) to prepare a slurry of Example 9. Thereafter, the obtained slurry was applied on carbon paper under atmospheric pressure and dried to prepare an electrode of Example 9.

### Comparative Example 4

An electrode of Comparative Example 4 was obtained in the same process as in Example 9 except that exposure in the reduced-pressure environment was not performed at the time of ionomer mixing.

### <<Evaluation>:

### <Configuration of CO₂ Electrolytic Apparatus>

The obtained electrode of Example 9 or Comparative Example 4 was used as a cathode, and a titanium mesh carrying iridium oxide was used as an anode. In addition, an anion-exchange membrane having an ion exchange capacity of 1.5 mmol/g and a thickness of 30 to 35 μm was used as a solid electrolyte. An electrolytic solution tank (0.5M KHCO₃ aqueous solution) was used as a solution on the anode side. A cathode, a solid electrolyte, an anode, and an electrolytic solution tank were arranged in this order to form a structure in which the cathode and the electrolytic solution tank sandwiched the ion-exchange membrane and the anode.

### <Measurement of CO Generation Partial Current Density>

Using this apparatus, CO₂ was supplied to the cathode, an applying potential of the cathode was −1.4 V to a silver/silver chloride reference electrode, CO₂ was electrolyzed, and a CO generation partial current density [mA/cm²] in generating CO was measured. The results are illustrated in Table 4. According to the results, it is presumed that in the case of using a catalyst carrying nickel monatomic particles, similarly to the case of using a silver catalyst, a good effect on reduction efficiency (CO generation partial current density) was achieved in the case of performing a pressure reducing treatment during ionomer mixing.

TABLE 4

| | Pressure Reducing | CO Generation Partial |
|---|---|---|
| | Treatment During | Current Density |
| | Ionomer Mixing | [mA/cm²] |
| Example 9 | Performed | 60 |
| Comparative | Unperformed | 50 |
| Example 4 | | |

### REFERENCE SIGNS LIST

1 Composite (or carrying target)
10 Carrier
11 Particles of elemental metal or metal compound
12 Polymer
100 CO₂ electrolytic apparatus
101 Negative electrode (Cathode)
101-1 Surface of cathode in contact with solid electrolyte (ion-exchange resin)
101-2 Surface of cathode in contact with current collector
102 Positive electrode (Anode)
102-1 Surface of anode in contact with support plate
102-2 Surface of anode in contact with solid electrolyte (ion-exchange resin)
103 Solid electrolyte (ion-exchange resin)
104 Current collector
104-1 Gas supply hole of current collector
104-2 Gas collecting hole of current collector
105 Support plate
105-1 Gas flow channel of support plate
106 Voltage applying unit

1. A method for manufacturing a composite in which at least one of an elemental metal or a metal compound is carried on a carrier, the method comprising:
exposing a dispersion liquid containing a solvent and the carrier to a reduced-pressure environment of less than 80 kPa (absolute pressure) at normal temperature;
preparing a raw material mixture liquid by mixing a metal-ion supplying agent which is a metal ion source of the elemental metal or the metal compound with the dispersion liquid; and
mixing a reducing agent with the raw material mixture liquid and causing the elemental metal or the metal compound to be carried on a surface of the carrier.

2. The method for manufacturing a composite according to claim 1, wherein the elemental metal or the metal compound contains any one of Au, Ag, Cu, Pt, Ir, Pd, Ru, Ni, Co, Mn, Bi, Sn, Zn, and Al.

3. The method for manufacturing a composite according to claim 1, wherein a metal content of a metal component of the elemental metal or the metal compound in the composite is 1 part by mass or more when a content of the carrier is 100 parts by mass.

4. The method for manufacturing a composite according to claim 1, wherein
the elemental metal or the metal compound contains a particle-shaped elemental metal or metal compound, and
the particle-shaped elemental metal or metal compound has an average particle size of 1 to 100 nm.

5. A method for manufacturing a slurry containing a polymer material and a composite in which at least one of an elemental metal or a metal compound is carried on a carrier, the method comprising:
exposing a first dispersion liquid containing a solvent (A) and the composite to a reduced-pressure environment of less than 80 kPa (absolute pressure) at normal temperature; and
preparing a slurry by mixing the polymer material with the first dispersion liquid.

6. The method for manufacturing a slurry according to claim 5, wherein
the composite is manufactured by a manufacturing method including
exposing a second dispersion liquid containing a solvent (B) and the carrier to a reduced-pressure environment of less than 80 kPa (absolute pressure) at normal temperature,
preparing a raw material mixture liquid by mixing a metal-ion supplying agent which is a metal ion source of the elemental metal or the metal compound with the second dispersion liquid, and
mixing a reducing agent with the raw material mixture liquid and causing the elemental metal or the metal compound to be carried on a surface of the carrier.

7. The method for manufacturing a slurry according to claim 5, wherein the elemental metal or the metal compound contains any one of Au, Ag, Cu, Pt, Ir, Pd, Ru, Ni, Co, Mn, Bi, Sn, Zn, and Al.

8. The method for manufacturing a slurry according to claim 5, wherein
the elemental metal or the metal compound contains a particle-shaped elemental metal or metal compound, and
the particle-shaped elemental metal or metal compound has an average particle size of 100 nm or less.

9. The method for manufacturing a slurry according to claim 5, wherein the polymer material contains an ion-exchange resin.

10. The method for manufacturing a slurry according to claim 9, wherein the ion-exchange resin contains an anion-exchange resin.

11. A method for manufacturing an electrode, comprising:
applying the slurry manufactured by the method for manufacturing a slurry according to claim 5 on a base material,
wherein the carrier is a conductive carrier.

12. An electrode manufactured by the method for manufacturing an electrode according to claim 11.

13. An ion-exchange membrane-electrode assembly comprising:
the electrode according to claim 12.

14. A CO₂ electrolytic apparatus comprising:
the ion-exchange membrane-electrode assembly according to claim 13.
